(19) United States
(12) Patent Application Publication
(10) Pub. No.: US 2015/0186921 A1
(43) Pub. Date: Jul. 2, 2015

(54) Wifi Landing Page for Remote Control of Digital Signs

(71) Applicant: Google Inc., Mountain View, CA (US)

(72) Inventors: Roy Want, Los Altos, CA (US); William Noah Schilit, Mountain View, CA (US)

(73) Assignee: Google Inc., Mountain View, CA (US)

(21) Appl. No.: 14/145,194

(22) Filed: Dec. 31, 2013

(51) Int. Cl. G06Q 30/02

(52) U.S. Cl. CPC G06Q 30/0241

(57) ABSTRACT

A digital sign may be controlled from a user device. The sign may broadcast a network identifier to which the user's device connects. Connecting to the sign may result in the device's web browser launching and displaying a landing page. The landing page may display buttons that can be utilized to control or interact with the digital sign.

### BACKGROUND

Digital signage is a fast-growing business and can be used as an advertising platform. Interacting with a digital sign may make the sign more attractive to prospective advertising targets or users. An interactive sign, therefore, may be viewed as both a billboard and a vending machine for digital content.

### BRIEF SUMMARY

According to an implementation of the disclosed subject matter, a digital sign that includes a wireless access point may transmit a network identifier. The wireless access point may comply with the 802.11 standard. One or more connection requests may be received. One of the connection requests may be selected as the first connection request. The unselected connection requests may be sent an indication that the digital sign is occupied or in use. In some configurations a challenge may be sent in response to the first connection request. A response to the challenge may be received and a determination may be made as to the validity of the response. A valid response may grant access to the user interface for control of the digital sign. A user interface for control of the digital sign may be provided. One or more commands may be received from a device displaying the user interface. A command may be a horizontal movement, a vertical movement, a diagonal movement, a select action, an alphanumeric input, etc. A display of the digital sign may be updated.

In an implementation, a device is provided that includes a display, a wireless access point, and a processor connected to the display and/or the wireless access point. The wireless access point may be configured to transmit a network identifier and receive a first connection request. The processor may be configured to provide a user interface for control of the digital sign. It may receive one or more commands from the user interface and update the display of the digital sign.

In an implementation, a scan for a network identifier may be performed. A network identifier may be selected from one or more network identifiers. In some configurations, a first connection request may be sent to the digital sign. A challenge may be received in response to the first connection request. A response to the challenge may be sent. A validation response from the digital sign may be received. A wireless access point associated with the network identifier and a component of a digital sign may be connected to. A user interface for control of the digital sign may be received. A command may be sent to the digital sign using the user interface for control. The command may cause a change in a display of the digital sign.

The disclosed implementations may allow a user to interact with a digital sign using an access point in the digital sign. Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 is an example interaction between the digital sign and the user's device as disclosed herein.

FIG. 4 is an example method for providing, by a digital sign, a user interface with which a user may navigate content displayed on the digital sign as disclosed herein.

FIG. 5 is an example device configured to broadcast a network identifier and provide a user interface to a device according to an implementation disclosed herein.

FIG. 6 is an example process of controlling a digital sign with a user interface provided on a user device as disclosed herein.

### DETAILED DESCRIPTION

A device such as a mobile phone, tablet, laptop, etc. can be connected to a digital sign using a variety of methods. Generating an intuitive connection process for an end-user while maintaining functionality of the digital sign as both a billboard and a vending machine for digital content can be difficult and/or complex. As disclosed herein, a user may associate a user device with a digital sign to enable the vending functionality while simultaneously using the user device to navigate or interact with the digital sign. For example, interaction with the digital sign may include paging left, paging right, selecting an item, and/or viewing content. Content may be downloaded to the user's device or a Universal Resource Identifier (“URI”) may be provided to the user's device.

Any suitable wireless and/or optical technology may be utilized to associate or pair two wireless devices (e.g., the user's device and the digital sign) such as Bluetooth, near-field communication (“NFC”), or a quick response (“QR”) code displayed on the sign. But many of these technologies are not simple and familiar to users. Connecting to the digital sign using Bluetooth may require a lengthy pairing process. NFC may not be supported by a large number of devices at present. A QR code may require a user device to have an application/camera with which to perform the scan and/or analysis thereof and some environments may utilize bright lighting which can hinder the scanning process.

Users are accustomed to connecting various devices to a network. Typically, a user will direct a device to scan for a wireless access point or signal and select a service set identifier (“SSID”) being broadcast by an access point with which the user would like to connect. If it is a protected service, the user will be prompted to enter a passcode to complete the connection. Some service providers permit open connection to a landing page (i.e., a web page). A user may switch to a web browser and either pay for the service or, if the user already has an account, enter the passcode on the web page.

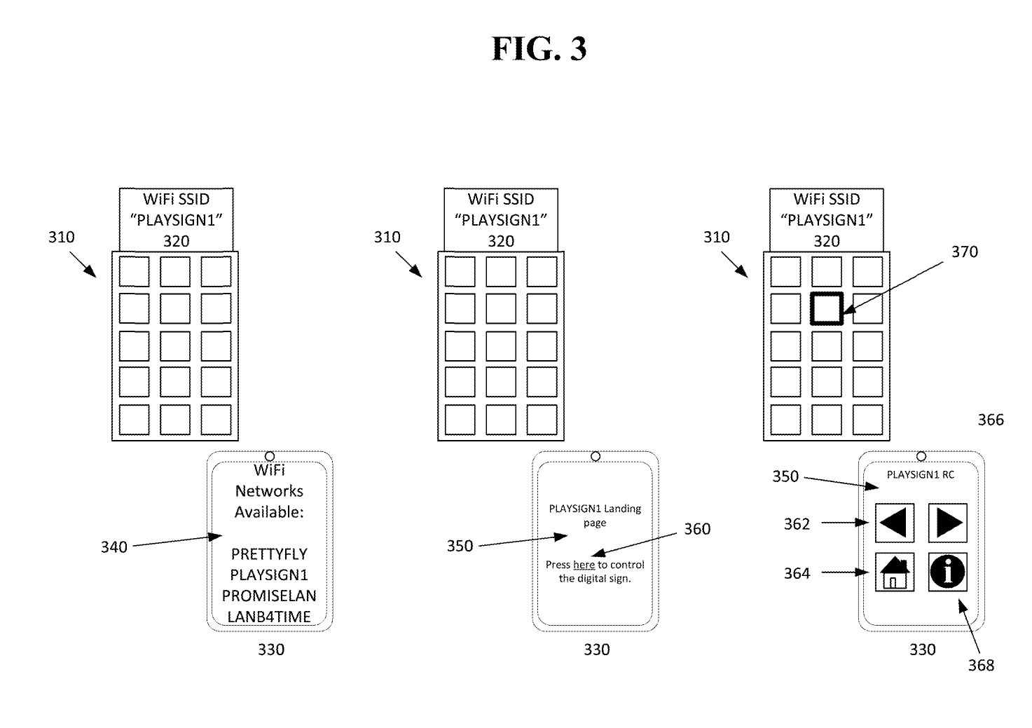

As disclosed herein, a user may interact with a digital sign. An example of how an interaction between the digital sign and the user's device is shown in FIG. 3. The digital sign 310 may act as a Wi-Fi hotspot. That is the sign may present a landing page 350 to a user's device 340 when the device attempts to pair with the digital sign's SSID (e.g., “PLAYSIGN1” as shown in FIG. 3). The sign's 310 access point may present a limited number of web pages to a user, for example, for content that the sign may vend. The sign 310 itself may be connected to a service provider and have access to the Internet.

To pair a device 330 with the digital sign 310, a user may initiate a scan for access points proximal to the device 330. As shown in FIG. 3, the user's device has displayed wireless access points 340 on the user's device 330 to which the user may connect the device 330. In some instances, a user's device 330 may automatically scan for access points nearby and notify the user of the available access points. The digital sign's SSID may be displayed on the sign itself or on a poster 320 next to the display. The sign's SSID may be selected to initiate the pairing process between the user's device and the digital sign. The digital sign 310 may direct a web browser on the user's device 330 to a landing page 350. In some configurations, the landing page 350 may require a user to enter a passcode or to select a button on the landing page 350 to complete the process. As shown in FIG. 3, a user must select the “here” hyperlink 360 to complete the pairing process between the user's device 330 and the digital sign 310. The landing page 350 may provide a panel of remote control buttons 362, 364, 366, 368 with which the user may interact with the digital sign. The controls 362, 364, 366, 368 may change depending on the content displayed on the sign 310. For example, if the user is browsing a media library, the user interface may have commands for up, down, left, right, select, and play content. If the sign is displaying an application library, the commands provided by the user interface on the landing page may be page left, page right, next category, previous category, select, download, and purchase. The example provided in FIG. 3 shows four commands for back 362, forward 366, home 364, and information 368 respectively. The forward 362 and back 366 buttons may be used to move the cursor 370 in the desired direction or otherwise navigate content displayed on the digital sign 310. The home button 364 may be used to return the digital sign 310 to a default display of content or return to a top level of a category of items, for example. The sign 310 may display a cursor 370 that highlights an application or content. The information button 368 may be used to provide additional information about the selection currently highlighted by the cursor 370.

A user may be required to enter a passcode such as a Personal Identification Number (“PIN”), alphanumeric sequence, etc. to ensure that the user in front of the display is actually the user who has control of display. The digital sign may dynamically display a three digit PIN. The user may be required to enter the PIN number on the landing page before the user is provided with the user interface for the digital sign. Other security measures may be used. For example, the sign may show a line graphic that the user must reproduce. The sign may direct the user to shake the phone at particular times either to the left, right up, or down. These latter two examples may be implemented through a canvas embedded in the landing page and determining the user's device's state by obtaining accelerometer data therefrom. Once a user passes a challenge presented by the display, the user may control the digital sign using the user interface controls provided on the landing page. Thus, the sign may limit control or interaction with the digital sign to a single user.

Information about the content that the user browsed while interacting with the digital sign or content vended to the user by the digital sign may be retained. A user's identity may refer to the user's name, email address, etc. A device identity may refer to a device serial number, a media access control address (“MAC”), etc. The digital sign may communicate with a remote server or database and store information about the identity of the user or user device, content displayed on the sign, and/or interaction of the user or user's device with the sign. When the user or user's device subsequently connects to the sign, the digital sign may query a database where the user's interactions with the sign have been stored to determine if the user or user device has previously contacted this particular digital sign or any digital sign. For example, if a user previously browsed mobile tower defense games on the digital sign, the digital sign may inform the user of the previous search the user conducted, the tower defense games the user browsed, the length of time the user spent browsing each game, etc.

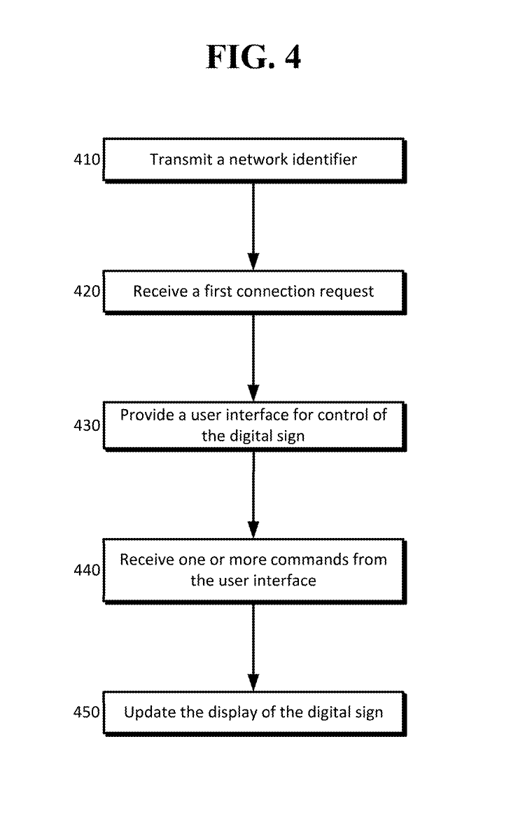

In an implementation, an example of which is shown in FIG. 4, a digital sign may include a wireless access point or other hardware sufficient to broadcast a SSID (e.g., a network identifier) or create a Wi-Fi hotspot. For example, the digital sign may include a WLAN controller to modulate a radio signal. The wireless access point may comply with the 802.11 standard. The digital sign may broadcast a network identifier such as a SSID at 410. A first connection request may be received at 420. The digital sign may continuously broadcast the network identifier. A device such as a smartphone, laptop, tablet, etc. may automatically scan for wireless connections or a user may direct the device to perform such a scan. The user may select the network identifier for the sign to initiate the pairing process. If the user has previously connected with the digital sign and configured to the device to remember the connection, the user's device may automatically attempt to pair with the sign when the device detects the network identifier. In the event another user is currently paired with the digital sign, the digital sign may indicate to the user that it is occupied or otherwise being controlled by a different user on a landing web page shown in a browser on the user's device. The user may pair with the digital sign by connecting with it similar to a wireless access point. The digital sign, therefore, may receive multiple connection requests and select the first connection request. The digital sign may utilize a variety of criteria in determining which connection request to accept. For example, the digital sign may select the first device that attempts to pair with it or it may accept the first device that successfully responds to a challenge.

A challenge may be sent, for example to a user device, in response to the first connection request. As described earlier, the landing page may require the user to enter a PIN or other passcode or trace a pattern to ensure that the user in front of the sign has control of it. A response to the challenge may be received. For example, the sign may determine that the PIN entered by the user matches the PIN currently displayed on the digital sign. Thus, the digital sign may determine that the response is valid and grant access to the user interface for control of the digital sign.

A user interface for control of the digital sign may be provided at 430. The digital sign may provide a user interface by causing the user's web browser to navigate to or otherwise display a landing page on which the user may be presented with controls to interact with the digital sign. The commands for the user interface may include a horizontal movement, a vertical movement, a diagonal movement, a select action, an alphanumeric input, etc. A command from the user interface may be received at 440, for example, by the digital sign. The user interface may be displayed on the landing page as stated earlier and may permit the user to interact with the sign. For example, the landing page may display a directional pad that is responsive to touch inputs of the user. That is, when the user selects the left arrow or left side of the directional pad, the digital sign may move a cursor or a highlight box to the left, for example. Thus, the display of the digital sign may be updated at 450 in response to the command received from the user interface.

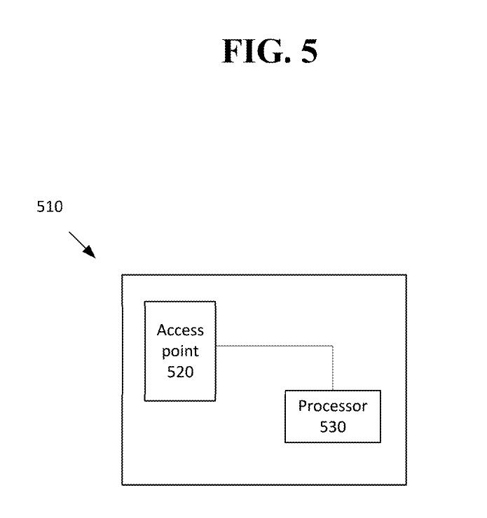

In an implementation, an example of which is provided in FIG. 5, a device is provided that includes a display 510, a wireless access point 520, and a processor 530. The wireless access point 520 may be configured to transmit a network identifier and receive a first connection request, for example, from a user device as described earlier. In some configurations, the access point may be physically integrated into the digital sign's enclosure. For example, the access point may draw power from circuitry enclosed by the digital sign and/or the access point may not be connected to the digital sign by an Ethernet cable. The processor 530 may be connected to the display 510 and the wireless access point 520. The processor 530 may be configured to provide a user interface for control of the digital sign. The processor 530 may receive one or more commands from the user interface and update the display 510 of the digital sign in response to a command received from the user interface. Updating the display 510 may refer to displaying a character input from the user interface, moving a cursor or a highlight box, etc.

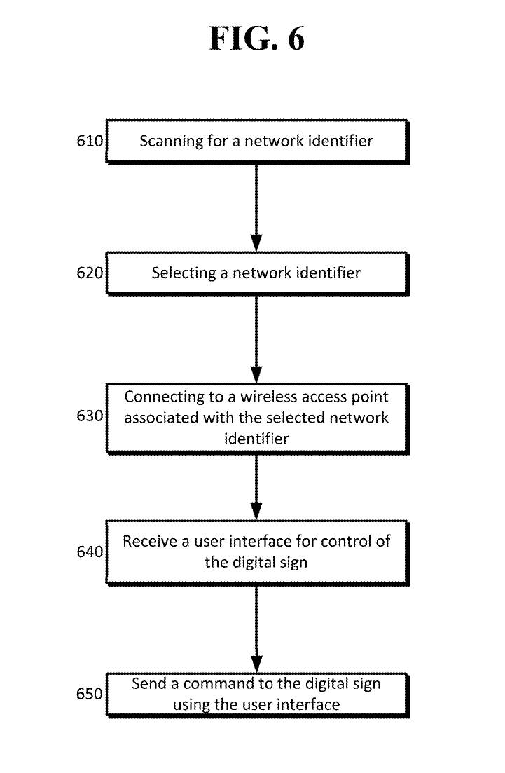

In an implementation, an example of which is provided in FIG. 6, a scan for a network identifier may be performed, for example, by a user device at 610. A network identifier may be selected at 620, for example, from a list of two or more network identifiers. As stated earlier, a user's device may automatically scan for wireless access points or a user may direct a device to conduct a scan for wireless access points. A connection to the digital sign's wireless access point associated with the network identifier may be established at 630. A user interface for control of the digital sign may be received at 640. Upon connecting or pairing with the digital sign, the digital sign may cause the user's web browser to display a web page (e.g., a landing page) that has a user interface for control of the digital sign at 650. Thus, the user interface may be received by the user's device by, for example, the digital sign causing the user's web browser to display a landing page or by the digital sign providing a URI to the user's device. The user interface control may be utilized to send a command to the digital sign using the user interface for control at 660 that may cause a change in a display of the digital sign.

As stated above, the user's device may send a request to the digital sign to initiate the pairing process and/or to connect with the digital sign's wireless access point. The user's device may receive a challenge in response to the connection request. The device may respond to the challenge and may receive a validation response from the digital sign. The validation response may be a display of the landing page on the user's device and/or the user interface for control of the digital sign.

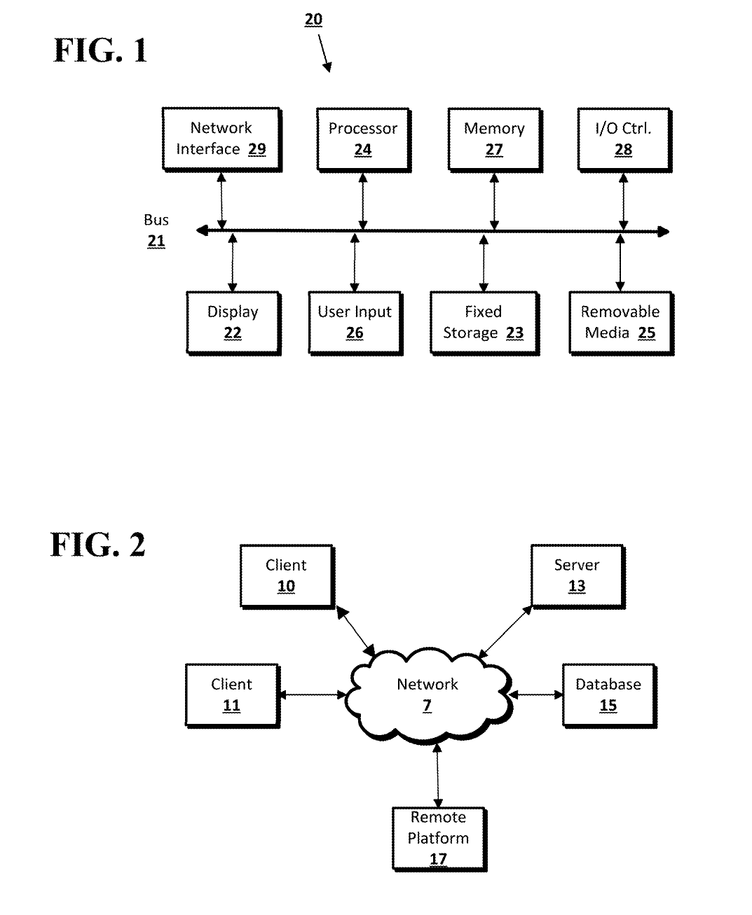

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1-22. (canceled)

23. A computer-implemented method comprising:
transmitting, by an interactive content distribution system comprising a digital sign, a network identifier;
receiving data indicating that a mobile computing device has selected the network identifier;
in response to receiving the data indicating that the mobile computing device has selected the network identifier, transmitting code for a user interface to the mobile computing device that has selected the network identifier, the user interface including at least one particular control that, when selected, instructs the interactive content distribution system to manipulate content provided by the digital sign;
receiving data indicating that one of the at least one particular control has been selected; and
in response to receiving the data indicating that the one particular control has been selected, manipulating, by the interactive content distribution system, the content provided by the digital sign.

24. The computer-implemented method of claim 23, wherein manipulating the content provided by the digital sign comprises one or more of:
selecting a content displayed by the digital sign;
navigating to a content displayed by the digital sign;
modifying content displayed on the digital sign; and
displaying new content on the digital sign.

25. The computer-implemented method of claim 23, wherein the digital sign comprises a wireless access point.

26. The computer-implemented method of claim 23, further comprising:
transmitting a challenge in response to receiving the data indicating that the mobile computing device has selected the network identifier and prior to transmitting the code for the user interface;
receiving a response to the challenge; and
determining that the response to the challenge is valid.

27. The computer-implemented method of claim 23, wherein receiving the data indicating that the one particular control has been selected comprises receiving, from the user interface, one or more selections of a horizontal movement, a vertical movement, a diagonal movement, a select action, and an alphanumeric input.

28. The computer-implemented method of claim 23, wherein the code for the user interface comprises code for receiving a selection to complete a pairing between the mobile computing device and the digital sign.

29. The computer-implemented method of claim 23, further comprising:
in response to manipulating the content provided by the digital sign, storing i) data indicating an interaction with the manipulated content, and ii) an identification of a user associated with the interaction;
retrieving the data indicating the interaction with the manipulated content upon a subsequent connection to the digital sign by the user associated with the interaction; and
displaying, on the digital sign, information corresponding to the retrieved data indicating the interaction with the manipulated content.

30. A non-transitory computer-readable storage medium encoded with a computer program, the computer program comprising instructions that, upon execution by a computer, cause the computer to perform operations comprising:
transmitting a network identifier;
receiving data indicating that a mobile computing device has selected the network identifier;
in response to receiving the data indicating that the mobile computing device has selected the network identifier, transmitting code for a user interface to the mobile computing device that has selected the network identifier, the user interface including at least one particular control that, when selected, instructs the computer to manipulate content provided by a digital sign;
receiving data indicating that one of the at least one particular control has been selected; and
in response to receiving the data indicating that the one particular control has been selected, manipulating the content provided by the digital sign.

31. The non-transitory computer-readable storage medium of claim 30, wherein manipulating the content provided by the digital sign comprises one or more of:
selecting a content displayed by the digital sign;
navigating to a content displayed by the digital sign;
modifying content displayed on the digital sign; and
displaying new content on the digital sign.

32. The non-transitory computer-readable storage medium of claim 30, wherein the digital sign comprises a wireless access point.

33. The non-transitory computer-readable storage medium of claim 30, further comprising:
transmitting a challenge in response to receiving the data indicating that the mobile computing device has selected the network identifier and prior to transmitting the code for the user interface;
receiving a response to the challenge; and
determining that the response to the challenge is valid.

34. The non-transitory computer-readable storage medium of claim 30, wherein receiving the data indicating that the one particular control has been selected comprises receiving, from the user interface, one or more selections of a horizontal movement, a vertical movement, a diagonal movement, a select action, and an alphanumeric input.

35. The non-transitory computer-readable storage medium of claim 30, wherein the code for the user interface comprises code for receiving a selection to complete a pairing between the mobile computing device and the digital sign.

36. The non-transitory computer-readable storage medium of claim 30, further comprising:
in response to manipulating the content provided by the digital sign, storing i) data indicating an interaction with the manipulated content, and ii) an identification of a user associated with the interaction;
retrieving the data indicating the interaction with the manipulated content upon a subsequent connection to the digital sign by the user associated with the interaction; and
displaying, on the digital sign, information corresponding to the retrieved data indicating the interaction with the manipulated content.

37. A system comprising:
one or more processors and one or more computer storage media storing instructions that are operable, when executed by the one or more processors, to cause the one or more processors to perform operations comprising:
transmitting a network identifier;
receiving data indicating that a mobile computing device has selected the network identifier;
in response to receiving the data indicating that the mobile computing device has selected the network identifier, transmitting code for a user interface to the mobile computing device that has selected the network identifier, the user interface including at least one particular control that, when selected, instructs the one or more processors to manipulate content provided by a digital sign;
receiving data indicating that one of the at least one particular control has been selected; and
in response to receiving the data indicating that the one particular control has been selected, manipulating the content provided by the digital sign.

38. The system of claim 37, wherein manipulating the content provided by the digital sign comprises one or more of:
selecting a content displayed by the digital sign;
navigating to a content displayed by the digital sign;
modifying content displayed on the digital sign; and
displaying new content on the digital sign.

39. The system of claim 37, wherein the digital sign comprises a wireless access point.

40. The system of claim 37, further comprising:
transmitting a challenge in response to receiving the data indicating that the mobile computing device has selected the network identifier and prior to transmitting the code for the user interface;
receiving a response to the challenge; and
determining that the response to the challenge is valid.

41. The system of claim 37, wherein receiving the data indicating that the one particular control has been selected comprises receiving, from the user interface, one or more selections of a horizontal movement, a vertical movement, a diagonal movement, a select action, and an alphanumeric input, and
wherein the code for the user interface comprises code for receiving a selection to complete a pairing between the mobile computing device and the digital sign.

42. The system of claim 37, further comprising:
in response to manipulating the content provided by the digital sign, storing i) data indicating an interaction with the manipulated content, and ii) an identification of a user associated with the interaction;
retrieving the data indicating the interaction with the manipulated content upon a subsequent connection to the digital sign by the user associated with the interaction; and
displaying, on the digital sign, information corresponding to the retrieved data indicating the interaction with the manipulated content.
